(19) United States
(12) Patent Application Publication
(10) Pub. No.: US 2024/0229643 A1
(43) Pub. Date: Jul. 11, 2024

(54) SYSTEM FOR MEASURING MULTIPHASE FLOW IN DOWNHOLE CONDITIONS AND FLOW REGIMES

(71) Applicant: CALIFORNIA INSTITUTE OF TECHNOLOGY, Pasadena, CA (US)

(72) Inventors: Stewart SHERRIT, Montrose, CA (US); Luis Phillipe C.F. TOSI, Los Angeles, CA (US); Kristopher V. SHERRILL, Pasadena, CA (US); Mina RAIS-ZADEH, Pasadena, CA (US); Jeffery L. HALL, Pasadena, CA (US); Jacob F. TIMS, Pasadena, CA (US); Mathieu FRADET, Pasadena, CA (US); Ryan M. BRIGGS, Pasadena, CA (US); Christopher R. YAHNKER, Pasadena, CA (US)

(21) Appl. No.: 18/277,310

(22) PCT Filed: Mar. 28, 2022
(86) PCT No.: PCT/US2022/022115

§ 371 Date: Aug. 15, 2023

Related U.S. Application Data
(60) Provisional application No. 63/168,877, filed on Mar. 31, 2021.

(51) Int. Cl. E21B 47/113; E21B 47/013; G01F 1/7086; G01F 1/74

(52) U.S. Cl. CPC E21B 47/113; E21B 47/013; G01F 1/7086; G01F 1/74

(57) ABSTRACT

Systems and methods for measuring multiphase flow of a fluid mixture in a downhole pipe of an oil/gas/water well are presented. According to one aspect, time-series measurement of the flow velocity and composition at a plurality of discrete azimuths of the pipe are measured. Measured time-correlated velocity and composition data are used to identify fluid components present in the pipe and estimate cross-sectional area and velocity of each of the fluid components. According to another aspect, pressure and temperature at the downhole pipe are measured, and used to calculate the mass density of each fluid component. For each of the fluid components, the cross-sectional area, velocity, and mass density are used to generate a corresponding mass flow rate. An algorithm with a set of parameters tuned to specific flow regimes is used to map the sensed data from the time-scrics measurements into the mass flow rate of each fluid component.

### CROSS REFERENCE TO RELATED APPLICATIONS

The present application claims priority to and the benefit of co-pending U.S. provisional patent application Ser. No. 63/168,877 entitled “System For Measuring Multiphase Flow In Downhole Conditions And Flow Regimes”, filed on Mar. 31, 2021, the disclosure of which is incorporated herein by reference in its entirety.

### TECHNICAL FIELD

The present disclosure generally relates to systems and methods for measuring multiphase flow in fluid mixtures, such as, for example, mixtures of oil, water and gas found in lateral oil/gas wells.

### BACKGROUND

Detailed information about physical properties (e.g., reservoir inflow) in the downhole of an oil-gas producing well, is important to help optimize production and field development. Inflow data points such as oil-gas-water flow rates, pressure, and temperature, for example, are key to understanding the nature of the reservoir properties and the effect of well drilling and completion methods. Although useful, the inflow data are not often measured in real-time, or with considerable frequency (weekly or more frequently), along the lateral section of the well due to technical or cost-prohibitive challenges. Instead, surface well-head production data (total flow rates, pressure, temperature, etc.) are measured for well performance diagnostics and for reporting purposes.

Attempts to instrument the well for real time or at least weekly measurements with continuous electrical or fiber optic cables for powering sensors to measure and deliver physical properties in the downhole of a well have been tested and have not been cost effective. This is particularly true for shale and tight development wells that have, for example, long laterals and multiple perforation entry points of their casing pipe (to contact the rock formation) which then undergo high-pressure hydraulic fracturing to increase hydrocarbon inflows from oil-bearing rock formations. Such harsh activities can easily damage not only the sensors but also power and data cables in the downhole of a well.

Production-logging tools (PLTs) are used routinely within long, horizontal wells to make measurements of local pressure, temperature, composition and flow rates. PLTs, however, are provided as a service and require well intervention for data to be collected; the operational cost and complexity limiting the frequency the data can be collected within a well.

Unconventional tight rock geologic formations may require a large number of oil/gas wells (holes) drilled in close proximity to each other to effectively extract the hydrocarbon contained in a field. Horizontally-drilled wells may be used in these applications since the hydrocarbon-bearing rock formations tend to exist in stratified layers aligned perpendicular to the gravity vector.

The typical vertical section of these wells can be 1-3 km below the surface and can extend laterally (e.g., in a generally horizontal direction) for distances of, for example, 2-3 km or even more. Oil, natural gas, and water may enter the well at many locations (production intervals/zones open to perforations and fracturing) formed along a lateral distance (e.g., 2-3 km or more) of the well with local flow rates and composition (e.g., oil/water fractions, relative concentrations, hold-up) varying due to inherent geology and the accuracy with which the well intersects (e.g., at the production intervals or sections) the oil-bearing rock formations. In general, information about the performance or hydrocarbon delivery and capacity of a well, such as, for example, flow rate, pressure, and composition, can practically be measured at the surface of the well as-combined values and with little or no knowledge of individual contributions from each of the production intervals or zones. Lack of local information of the inflow details of the well, at, for example, the production intervals or zones, can be a barrier to improving the efficiency of oil-gas extraction from the overall field.

Better knowledge of local interval inflow data across each or multiple entry points (e.g. physical properties such as flow rates, pressure, temperature, etc.) at the downhole of a well (e.g., along the horizontal/lateral section of the well) may help in making better decisions about placement of subsequent perforation/completion intervals for production in a well and/or subsequent drilling of other wells in the field.

For example, an oil production field may have a variety of drilled wells, including an unconventional horizontal oil well that extracts oil from shale and tight formation through a plurality of production intervals or zones (e.g., shown as rectangles in FIG. 1). In order to develop the field, producing the hydrocarbon-bearing rock formations, a number of wells (i.e., holes) may be drilled and spaced, for example, in the order of 500 feet apart from each other. These wells are drilled and completed serially so that information may be gathered from a downhole of a first well, for example, and can aid in determining where to perforate the casing and to apply hydraulic fracturing at selected intervals of the formation in a second and following well.

### SUMMARY

Although the present systems and methods are described with reference to wells used in the oil industry, such systems and methods may equally apply to other industries, such as, for example, deep sea exploration or through-ice exploration. Furthermore, although the present systems and methods are described with reference to oil-gas-water mixtures found in oil wells, such systems and methods may equally apply to any other fluid mixtures.

According to one embodiment the present disclosure, a system for measuring mass flow rate in a downhole pipe of a lateral section of a well is presented, the system comprising: a mobile vessel configured for submersion into a fluid mixture of the downhole pipe; a flow velocity sensor attached to the mobile vessel, the flow velocity sensor configured to rotate about a longitudinal center axis of the mobile vessel for placement according to a plurality of discrete angular positions of a velocity sensing region of the flow velocity sensor; a composition sensor attached to the mobile vessel, the composition sensor configured to rotate about the longitudinal center axis of the mobile vessel for placement according to a plurality of discrete angular positions of a composition sensing region of the composition sensor; and processing means configured to use a plurality of time-series measurements of velocity and composition of the fluid mixture sensed at the plurality of discrete angular positions of the velocity and composition sensing regions to determine a total cross-sectional area and flow velocity of each of a plurality of fluid components of the fluid mixture.

According to a second embodiment of the present disclosure, a system for measuring mass flow rate of a fluid mixture is presented, the system comprising: a submersion vessel configured for submersion into the fluid mixture; a flow velocity sensor attached to the submersion vessel, the flow velocity sensor configured to rotate about a longitudinal center axis of the submersion vessel according to a plurality of discrete angular positions; a composition sensor attached to the submersion vessel, the composition sensor configured to rotate about the longitudinal center axis of the submersion vessel according to a plurality of discrete angular positions; and processing means configured to use a plurality of time-series measurements of velocity and composition of the fluid mixture sensed at the plurality of discrete angular positions to determine a total cross-sectional area and flow velocity of each of a plurality of fluid components of the fluid mixture.

According to a third embodiment of the present disclosure, a method for measuring mass flow rate velocity of a fluid mixture is presented, the method comprising: performing a plurality of time-series measurements of velocity and composition of the fluid mixture at a plurality of discrete angular positions relative to a center axis; based on the performing, obtaining time-correlated measurements of the velocity and composition at each of the discrete angular positions; based on the obtaining, identifying a plurality of fluid components of the fluid mixture; and based on the obtaining and the identifying, determining a total cross-sectional area and flow velocity of each of the plurality of fluid components.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a cross sectional view of an example known oil production field, comprising one or more drilled wells for production of oil and/or gas in which a mobile vessel constructed in accordance with this disclosure may be disposed.

FIG. 2 shows a lateral section of a well of the oil production field shown in FIG. 1 comprising a plurality of production zones in which a mobile vessel constructed in accordance with this disclosure may be used.

FIG. 3 shows a mobile vessel according to an exemplary embodiment of the present disclosure comprising a flow velocity sensor and a composition sensor, the mobile vessel positioned in a lateral section of a well of the oil production field shown in FIG. 1.

FIG. 4A shows a front view of the mobile vessel of FIG. 3 with the flow velocity sensor and the composition sensor positioned at a first angular position.

FIG. 4B shows a front view of the vessel of FIG. 3 with the flow velocity sensor and the hold-up sensor positioned at a second angular position.

FIG. 5A shows an exemplary multiphase flow surrounding the vessel shown in FIG. 4B.

FIG. 5B shows graphs representative of flow velocity and composition measured by sensors of the vessel shown in FIG. 5A at different angular positions.

FIG. 6 shows various steps of an algorithm according to an embodiment of the present disclosure for determining mass flow rate of each fluid component of a multiphase flow.

FIG. 7A shows the mobile vessel of FIG. 3 within a casing pipe of a lateral well, the LDV-based flow sensor arranged in a nose of the mobile vessel.

FIG. 7B shows the mobile vessel of FIG. 3 within a casing pipe of a lateral well, the LDV-based flow sensor arranged in a main body of the mobile vessel.

FIG. 7C shows an example embodiment of another mobile vessel comprising the LDV-based flow sensor according to the present disclosure.

Like reference numbers and designations in the various drawings indicate like elements.

### Definitions

As used herein the term “flow velocity” of a fluid may refer to the motion of the fluid per unit of time and may be represented locally by a corresponding “fluid velocity vector”. As used herein, the term “flow rate”, or “volume flow rate”, of a fluid may refer to a volume of the fluid flowing past a point per unit of time. Therefore, considering a cross-sectional area of a flow of fluid, such as a flow of fluid through a lateral section of an oil well, the flow rate through the cross-sectional area can be provided by the flow velocity at that area.

As used herein the term “mass flow rate” of a fluid may refer to a mass of the fluid flowing past a point per unit of time. Therefore, the mass flow rate of a fluid may be obtained by multiplying the volume flow rate of the fluid by the mass density of the fluid (e.g., p).

As used herein the terms “hold-up” and “composition” may be interchangeable and refer to a fraction of a particular fluid of a multiphase fluid (e.g., a fluid mixture) present in an interval of a lateral section of an oil well (e.g., a pipe). Hold-up may be measured by a fluid composition sensor that may sense ratios of different fluid components of the multiphase fluid.

As used herein the term “infrared”, “infrared light” and “infrared emission” are synonymous and may refer to an electromagnetic radiation (EMR) with wavelengths in a range from about 780 nanometers to 1 millimeter and longer than those of visible light. As used herein the term “near infrared”, “near infrared light” and “near infrared emission” are synonymous and may refer to an electromagnetic radiation (EMR) with wavelengths in a range from about 780 nanometers to 3,000 nanometers.

### DETAILED DESCRIPTION

As set forth above, information may be gathered from a downhole of a first well, for example, and can aid in determining where to perforate the casing and to apply hydraulic fracturing at selected intervals of the formation in a second and following well. It is understood that the downhole of an oil well may include a (multiphase, non-homogeneous) fluid mixture that may include different components having different phases in dependence of different thermodynamic conditions, the different phases including a liquid phase and a gaseous phase. Systems and methods according to the present disclosure allow measurement of the mass flow rate of each of the (flow/fluid) components (e.g., oil, water, gas).

In particular, presented herein is a system that may include a flow velocity sensor and a composition sensor integrated with a mobile vessel. According to an embodiment of the present disclosure, the flow velocity and composition sensors may rotate relative to a longitudinal (center) axis of the mobile vessel. Accordingly, when the mobile vessel is placed in a downhole of an oil pipe with its longitudinal axis according to an axial direction of the pipe, time-series measurements of the flow velocity and composition may be provided over each angular position (azimuth) of a multiple of discrete angular positions (azimuths). Corresponding sensed data may be stored and processed either locally within the mobile vessel or at a location that is external to the mobile vessel (e.g., at the surface) to derive mass flow rates of each fluid component.

According to an embodiment of the present disclosure, sensed data from the time-series measurements may be combined such as to estimate the total cross-sectional area and representative velocities of each fluid component of the downhole pipe. According to an embodiment of the present disclosure, an algorithm with a set of parameters that are tuned to specific flow regimes may be used to map the sensed data from the time-series measurements into the mass flow rate of each fluid component. According to an embodiment of the present disclosure, such parameters may include the discrete increment between two azimuth positions, the total (measurement) time at each discrete position, and any geometry parameters that define the composition and flow velocity sensors as they interact with the surrounding flow (e.g., geometries of respective protrusions of the sensors into the flow, including height and/or diameter of the respective protrusions, and/or relative distance between the respective protrusions).

Teachings according to the present disclosure for derivation of the mass flow rates of individual components of a multiphase fluid may further include measurement of thermodynamic state variables of the fluid mixture, including, for example, (local) temperature and pressure. Such measurement of the thermodynamic state variable may provide increased accuracy in estimation of local fluid densities and viscosities that may be used in the derivation of the mass flow rate of each component of the multiphase fluid.

Teachings according to the present disclosure may be independent of a type of mobile vessel used for integration of the flow velocity or composition sensor so long it can adapt to requirements imposed by the type of sensors selected, and be operable in the harsh environment of the downhole of an oil pipe, including operable to travel along the lateral section of the oil well, position at any location along the lateral section of the oil well, and rotate (e.g., stepwise) the sensors about an axial direction of the lateral section of the oil well.

Teachings according to the present disclosure for derivation of the mass flow rates of individual (flow/fluid) components of a multiphase fluid may be independent of a type of the flow velocity or composition sensor. In other words, teachings according to the present disclosure may adapt to any known in the art flow velocity and/or composition sensor that may provide robust and accurate operation in the harsh environment of the downhole of an oil pipe.

Types of flow velocity sensors compatible with the present teachings may include, for example, i) a laser doppler velocimetry-based flow sensor that tracks features in a sensing region of the fluid mixture via backscattered light generated when the features travel through a diffraction pattern that the sensor generates inside of the sensing region; ii) a strain gauge flow sensor that includes one or more cantilevers having respective planar sensing surfaces coupled to respective strain gauge transducers, iii) a camera-based flow sensor that detects and tracks features in a sensing region of the fluid via a camera and lighting system, or detects and tracks quantum dot illuminators injected into the flow, or iv) other known in the art flow sensors that include spinners (e.g., impeller) that rotate with angular speeds proportional to incident flow rates.

Types of (hold-up) composition sensors compatible with the present teachings may include, for example, i) an absorption-based composition sensor that includes at least three super light-emitting diodes that emit time-multiplexed light at different wavelengths (e.g., in the infrared region) into the fluid mixture to discern between oil, water, and gas based on relative absorption of the emitted light through the fluid mixture; or ii) a capacitive and/or resistive based composition sensor, where a capacitance or resistance is measured relative to a change in a dielectric of a fluid component that is in contact with the sensor.

It should be noted that some of the above mentioned flow velocity and/or composition sensors may be considered as “solid-state” type sensors that are devoid of mechanical parts that move when in contact with the fluid flow. Such sensors may provide greater measurement accuracy independently from flow composition (e.g., oil, gas, or water) while operating unattended for extended periods of time. When integrated with a mobile vessel, such solid-state type sensors may measure flow velocities and/or composition of a fluid mixture of the downhole under a wide range of thermodynamic conditions, including at downhole pressures greater than 5000 psi, accurately and efficiently.

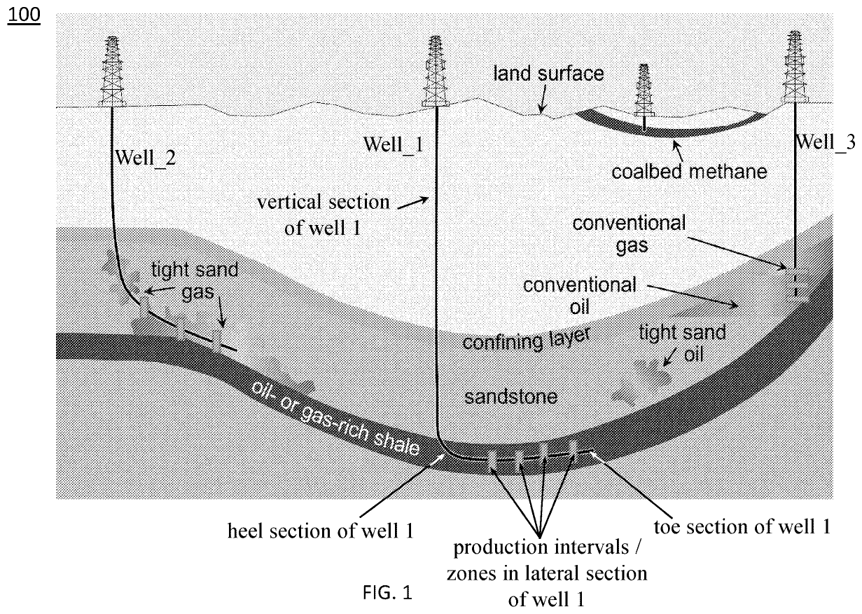

The mobile vessel described herein may be used in a number of settings, an example of which is depicted in FIG. 1, which illustrates a cross sectional view of an example oil production field (100), comprising one or more drilled wells (Well_1, Well_2, . . . ) for production and extraction of oil and/or gas from various regions of the field. In particular, as can be seen in FIG. 1, a vertical section of the Well_1 may be drilled to reach and penetrate an oil- or gas-rich shale (e.g., rock formation), and a lateral (e.g., horizontal) section of the Well_1, which, in the example case of FIG. 1 is substantially horizontal, may be drilled along the shale, starting from a heel section of the Well_1, and ending at a toe section of the Well_1. Generally, the vertical section of the Well_1 may extend 1 to 3 km below the surface and the lateral section of the Well_1 may extend for distances of, for example, 2-3 km or more.

With continued reference to FIG. 1, fluid mixtures, including (crude) oil, water, and/or natural gas mixtures, may enter the Well_1, for example, through open-hole or a casing of the Well_1, at production perforated intervals/zones that may be formed in the lateral section of the Well_1. Each of such production intervals/zones may include holes and/or openings that extract the fluid from the shale and route into the casing of the Well_1. As shown in FIG. 1, the perforated intervals/production zones may be separated by distances of, for example, about 100 meters (e.g., about 300 feet), and between each of the intervals (or stages) there are several clusters of perforations with closer spacing in order to cover a lengthy lateral and extract more hydrocarbon from shale/tight formations. Since there are many production zones, the inflow contribution for each of the intervals (or zones or clusters), such as, for example, local pressure, temperature, flow rates, and composition, may vary due to inherent geology and the accuracy with which the lateral section of the Well_1 intersects the oil-bearing rock formations at the production zones.

Collecting data at regions of the Well_1, for example close to each of the production zones, can help evaluate effectiveness of inflow contribution for each of the production zones and further help in optimizing production (e.g., by altering the perforation/completion design). When integrated with a mobile vessel as described herein, the flow velocity and composition sensors may be used to determine the mass flow rate of each fluid component of a multiphase flow in the lateral section of the Well_1. In some cases, derivation or estimation of the mass flow rate may be based on calibration routines that may further take into account any perturbation of the flow of the fluid in a region of the mobile vessel and/or of the sensors. For example, such calibration routines may consider a flow restriction (e.g., variation of an effective cross-sectional area for the flow of the fluid) in a region of the sensors (e.g., due to sensors protrusion into the flow) that may result in a higher velocity as measured.

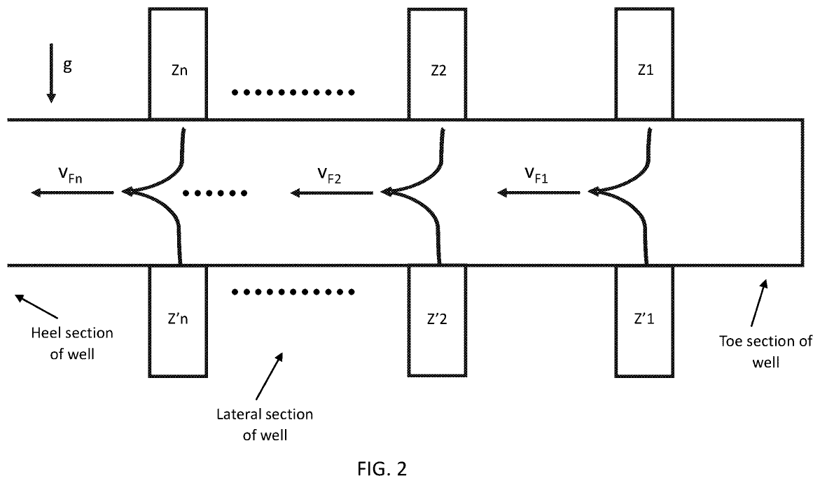

FIG. 2 shows a lateral section of a well of the oil production field shown in FIG. 1 comprising a plurality of production zones indicated as (Z1, Z′1 . . . . , Zn, Z′n). Also shown in FIG. 2 are local fluid velocity vectors (V_{F1}, . . . . V_{Fn}) at vicinity of respective production zones. For example, the fluid velocity vector V_{F1}, may be considered solely based on an inflow (of fluid) contribution by the last production zone (Z1, Z′1) close to the toe section of the well. On the other hand, the fluid velocity vector VF2 may be considered based on a combination of the inflow contribution of the production zone (Z2, Z′2) combined with the inflow contribution of the last production zone (Z1, Z′1). A performance of each of the production zones (Z1, Z′1 . . . . , Zn, Z′n) based on a corresponding inflow contribution may be assessed by, for example, measuring/estimating, a difference between a mass flow rate of a fluid component before and after each production zone. As described above, the mass flow rate for each of the production zones (Z1, Z′1 . . . . , Zn, Z′n) may be measured/estimated based on time-series measurements of the flow velocity and composition at a plurality of discrete angular positions.

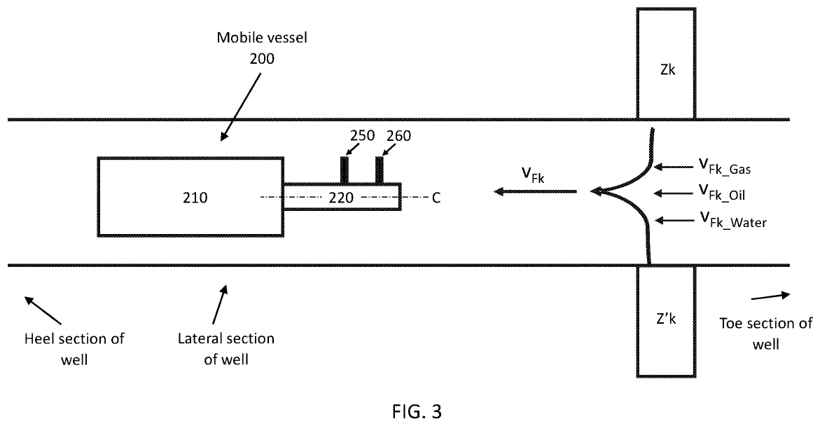

FIG. 3 shows a mobile vessel (200) according to an exemplary embodiment of the present disclosure comprising a flow velocity sensor (250) and a composition sensor (260), the mobile vessel (200) positioned downstream (e.g., towards the heel section of the well) of the production zone (Zk, Z′k) in a lateral section of a well of the oil production field shown in FIG. 1. When integrated with the mobile vessel (200), such as a mobile robot, the flow velocity sensor (250) may be used to measure the magnitude of the local fluid velocity vector, V_{Fk}, and the composition sensor (260) may be used to measure relative concentrations of oil, water and gas at the production zone (Zk, Z′k). In this case, the mobile vessel (200) may be controlled to remain stationary during the gathering/sensing of corresponding measurement data and move to a next production zone for a next measurement.

In some embodiments, actual measurement/estimation of the magnitude of the local fluid velocity vector and/or of the relative concentrations of fluid components (e.g., oil, water and gas) may be performed either in real-time or non-real-time based on data sensed by the flow velocity sensor (250) and/or the composition sensor (260), which, in some cases, may be combined with data sensed by other sensors as described above. It should be noted that the term “data” as used herein may relate to an ensemble of data values representative of signals gathered/sensed by one or more sensors of the mobile vessel (200). Such data may be stored on local or remote memory for immediate or future use. In the particular case of the flow velocity and composition sensors (250, 260), such data may include sensed data from time-series measurements of the flow velocity and composition taken over each angular position (azimuth) of a multiple of discrete angular positions (azimuths). When processed through an algorithm with a set of parameters that are tuned to specific flow regimes, such sensed data may be mapped into the mass flow rate of each fluid component. As shown in FIG. 3, each of the fluid components (e.g., oil, water, and gas) at the production zone (Zk. Z′k) may be represented by a corresponding fluid component velocity vector (V_{Fk_Oil}, V_{Fk_Water}, V_{Fk_Gas}) which may combine to generate the local fluid velocity vector, V_{Fk}. Teachings according to the present disclosure may allow measurement/estimation of the (component) mass flow rate via measurement/estimation of each of the fluid component velocity vectors (V_{Fk_Oil}, V_{Fk_Water}, V_{Fk_Gas}) in combination with the mass density of the fluid component determined via measurement of thermodynamic state variables of the fluid mixture, including, for example, (local) temperature and pressure.

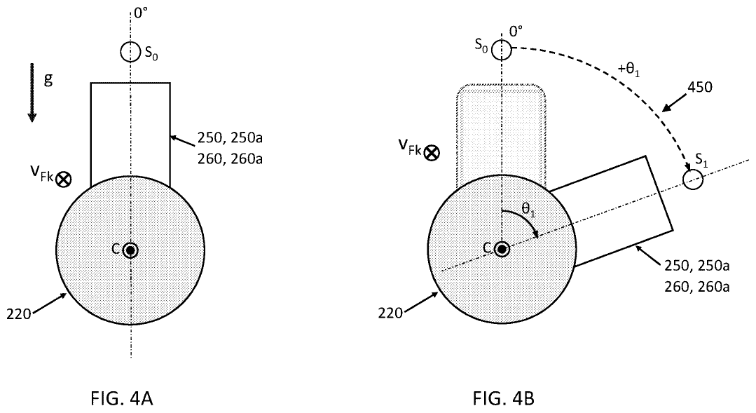

FIG. 4A shows a front view of the mobile vessel of FIG. 3 with the flow velocity and composition sensors (250, 260) positioned at a first angular position (e.g., reference zero position) about a (longitudinal) center axis, C, of the element (220, e.g., nose) of the mobile vessel (200) shown in FIG. 3. The center axis C may be a common axis of the elements (210) and (220) of the mobile vessel (200) as shown in FIG. 3 or may be an axis that is different from (e.g., parallel to) a center axis of the element (210, e.g., main body) of the mobile vessel. According to some example embodiments, the elements (210) and (220) of the mobile vessel (e.g., 200 of FIG. 3) may include a tubular or cylindrical shape about the center axis C, or about a respective center axis. Also shown in FIG. 4A is a direction of the local fluid velocity vector VEK which in the example configuration of FIG. 4A is assumed (substantially) parallel to an axial direction of the lateral portion of the well, as also shown in FIG. 3. The first angular position of the sensors (250, 260) may be referred to a reference zero degrees (i.e., 0°) angular position corresponding to a position of respective longitudinal extensions of the sensors (250, 260) in a substantially parallel direction to the gravity vector g (e.g., perpendicular to the center axis C).

As shown in FIG. 4A, the sensors (250, 260) may each include a respective enclosure or mast (250a, 260a) that protrudes the element (220) of the mobile vessel. In some sensor implementations (e.g., solid-state type sensors), the sensors (250, 260) may be fully or partially enclosed in a respective (sealed) enclosure/housing (250a, 260a) that protects internal elements of the sensor (250 or 260) against the outside environment (e.g., well environment). Each of the enclosures/masts (250a, 260a) may include an axis of symmetry that as shown in FIG. 4A may pass through the center axis, C, of the element (220) and through a measurement/sensing region S₀ of the respective sensor (250 or 260). In some sensor implementations, a shape of the enclosures/masts (250a or 260a)) may be cylindrical so to reduce perturbation of the fluid at vicinity of the respective sensor (250 or 260). Other shapes, including shapes about the axis of symmetry may be envisioned, with a corresponding perturbation of the flow factored in a calibration routine used to determine an effective velocity of the flow.

FIG. 4B shows the flow velocity and composition sensors (250, 260), and therefore the respective enclosures/masts (250a, 260a), at an angular position that is different by an angle +θ₁ from the (reference) angular position of the sensors (250, 260) shown in FIG. 4A. Such rotation of the sensors (250, 260) about the center axis C may be considered as a rotation in the azimuth direction of the lateral portion of the well which therefore allows derivation of azimuthal profiles (e.g., time-series measurements) of the flow rate and composition. As shown in FIG. 4B, rotation of each of the sensors (250, 260) may rotate a respective sensing region (e.g., S₀, S₁, . . . ) about a sensor radius (450) whose center passes through the center axis C of the element (220, e.g., nose). In other words, each of the sensing regions (e.g., S₀, S₁, . . . ) may be considered a radial region with respect to the center axis, C.

With continued reference to FIG. 4B, in some implementations, the rotation of the sensors (250, 260) may be based on a rotation of the element (220) to which the sensors (250, 260) are rigidly coupled. In such configuration, the element (220), which may be referred to as a nose of the mobile vessel (200 of FIG. 3), may be a rotating part of the mobile vessel. Rotation of the nose (220) may be dependent on or independent from a rotation of the vessel itself (e.g., 210 and 220 rotating in unison). The nose (220) may rotate clockwise and/or counterclockwise to achieve a desired angular position of each of the sensors (250, 260). It should be noted that rotation of each of the sensor (250) may be independent from rotation of the sensor (260), or in other words, the two sensors may simultaneously sense flow velocity and composition at a same angular position, or at different angular positions. In some cases, and during a time-series measurement of the flow velocity and composition at a given azimuth, it may be beneficial to provide a non-zero offset in the relative angular position of the two sensors (250, 260) such as to, for example, avoid or reduce effects of proximity of one sensor to the other.

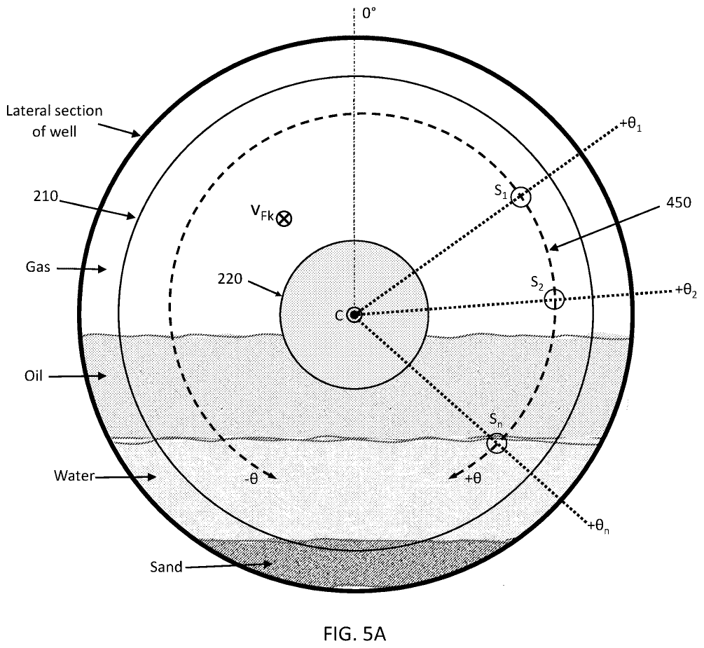

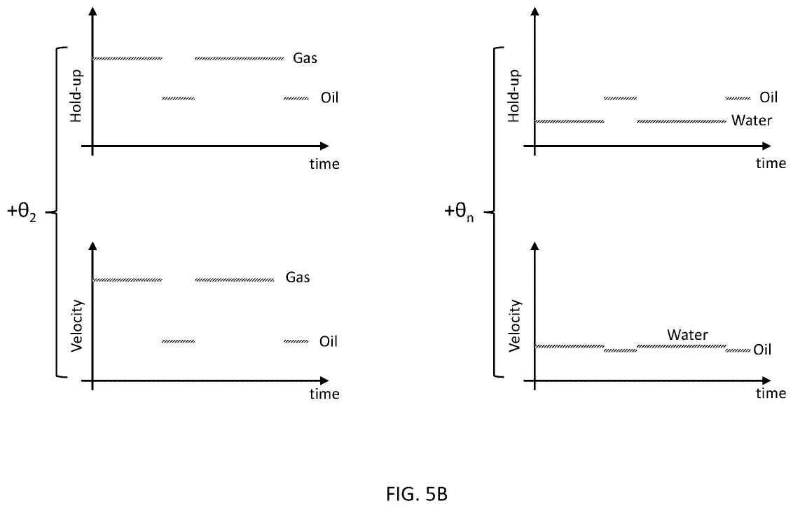

FIG. 5A shows an exemplary multiphase flow surrounding the vessel shown in FIG. 4B. As shown in FIG. 5A, when the vessel (210, 220) is positioned inside of the casing of the lateral section of the oil well, it may be surrounded by a downhole composition that may include a mixture of gas, oil and water atop a bottom layer of sand/sediments. Accordingly, rotation (e.g., +/−θ) of the sensors (250, 260) about the center axis, C, may allow sensing of the flow velocity and composition at different angular positions/azimuths along the sensor radius (450) where different (flow) compositions may be present. Accordingly, for any location/longitudinal position along the casing, a complete (e.g., 360°) profile of the flow velocity and composition may be captured/sensed/measured. In the particular nonlimiting case shown in FIG. 5A, the two sensors are assumed aligned in azimuth, or in other words, include respective sensing regions (e.g., S₀, S₁, . . . , Sₙ) at a same angular position but different axial positions (e.g., non-zero axial distance between the two sensors).

FIG. 5B shows graphs representative of flow velocity and composition measured by sensors (e.g., 250, 260 of FIG. 3) of the vessel shown in FIG. 5A at two discrete angular positions θ₂ and θₙ. As shown in FIG. 5B, the (time-series) measurements for the flow velocity (annotated as Velocity) may correlate with those of the composition measurement (annotated as Hold-up) in time when considering the geometry parameters of the two sensors (e.g., their relative position axially and in some cases their relative position in azimuth) at a given discrete angular position (e.g., θ₂ or θₙ). It should be noted that the two sensors may be arranged (e.g., integrated in the mobile vessel 200 of FIG. 3) close enough to one another in axial distance such that, throughout each of the time-series measurements at the discrete angular positions (e.g., θ₂ or θₙ), their respective sensing regions (e.g., S₂. Sₙ) may remain in a same fluid component. After a set time period corresponding to one time-series measurement cycle has passed (e.g., at discrete angular position θ₂ of the sensing regions S₂ shown in FIGS. 5A-5B), the sensors (e.g., 250, 260 of FIG. 3) are moved to a next incremental azimuthal position (e.g., at discrete angular position On of the sensing regions Sₙ shown in FIGS. 5A-5B), by rotating the nose about the axial pipe direction (e.g., axis C), and the time-series measurement process repeated.

According to an embodiment of the present disclosure, the set time period of the respective time-series measurements may be same or different for different discrete angular positions (e.g., θ₂ or θₙ) and determined by the observed flow regime. For example, considering a fixed axial distance between the two sensors (e.g., 250, 260 of FIG. 3), the set time period may be selected to be shorter for a higher velocity flow when compared to a lower velocity flow. In other words, the set time period may be long enough to allow sufficient “flow through time” where sufficient fluid particles/features may have traveled through the sensing regions (e.g., (e.g., S₂. Sₙ) of the two sensors for accurate sensing/operation of the sensors. Length of such set time period may be in a range from 0.5 seconds to 60 minutes. Under typical downhole conditions, the set time period may be set in a range from 30 to 60 seconds.

With continued reference to FIG. 5B, since the measurements for the flow velocity (annotated as Velocity) may correlate in time (i.e., time-correlated) with those of the composition measurement (annotated as Hold-up) for a given discrete angular position, according to an embodiment of the present disclosure, such correlation (e.g., time-correlated measurements of flow velocity and composition) may be used for identification of all fluid components/phases (and respective flow velocities) present at a cross section of the downhole pipe. This can be provided by performing a sufficiently large number of time-series measurements spread across various angular positions of the cross section. Furthermore, since an angular position (azimuth) of each of the time-series measurement is known relative to a reference angular position (e.g., reference zero degrees, 0°), (radial) mapping of each of the identified fluid components at the cross section of the downhole pipe may be provided. It should be noted that teachings according to the present disclosure may not be limited to measurements of the flow velocity and of the composition that are concurrent in time, rather, such measurements may be such as to correlate in time, or in other words, be correlated in time, or time-correlated. Such correlated in time, or time-correlated, measurements may allow to first sense a signal from the velocity sensor, and then, at a later time, sense a signal from the composition sensor (or vice-versa), while being able to correlate the two sensed signals so that correspondence between a phase/fluid and its velocity can be made. The expected correlation time, or a time difference between a sensed velocity signal and a sensed composition signal, may be a function of a distance between the two sensors. For example, the further the two sensors are apart from one another, the longer the correlation time between the two sensed signals. Accordingly, the time scales in the graphs shown in FIG. 5B for a given discrete angular position (e.g., θ₂ or θₙ) may not be a priori aligned, rather possibly shifted by the correlation time.

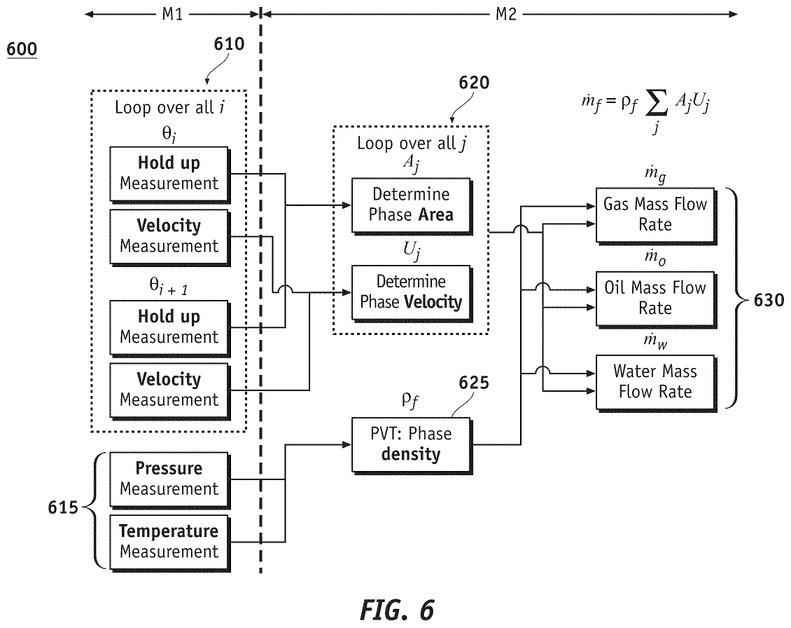

FIG. 6 shows various processing steps of an algorithm (600) according to an embodiment of the present disclosure for determining mass flow rate (e.g., mf of a fluid f) of each fluid component (e.g., f equal to g, o or w for gas, oil or water) of a multiphase flow. As shown in FIG. 6, such steps may include processing steps (610, 615) which may be (optionally) grouped as part of a first measurement phase M1, and processing steps (620, 625, 630) which may be (optionally) grouped as part of a second measurement phase M2. As shown in FIG. 6, the processing step (610) may correspond to performing of the described number of time-series measurements of the flow velocity (annotated as Velocity) and composition (annotated as Hold-up) at different angular positions, θᵢ, where the index, i, may indicate a discrete angular position of a plurality of angular positions (θᵢ, i=1, 2, . . . , n) at which a time-series measurement is performed. Output of the processing step (610) may be used by the processing step (620) to determine (e.g., estimate) a number of fluid components present in the downhole pipe, and for each such fluid component, represented in FIG. 6 by an index, j, determine/estimate a respective (cross-sectional) area (e.g., Determine Phase Area) and a respective flow velocity (e.g., Determine Phase Velocity) at the cross section of the downhole. For example, for i=1, 2, . . . , n, a number n of time-series measurements at n different angular positions, θᵢ, may be performed during the processing step (610); time-correlated flow velocity and composition data from the processing step (610) may be input to the processing step (620) for identification of three (i.e., j=1, 2, 3) fluid components (e.g., gas, oil, water), and for determination/estimation of a corresponding cross-sectional area, Aⱼ, and phase velocity, Uⱼ.

With continued reference to FIG. 6, at processing step (615), pressure and temperature at the downhole pipe are measured, and used as input to the processing step (625) where a (well-known in the art) representative state equation for the pressure-volume-temperature (PVT) relationship is used to calculate the mass density, p_{f}, of each fluid component. Accordingly, since for each of the fluid components respective cross-sectional area, Aⱼ, phase velocity, Uⱼ, and mass density, p_{f}, are provided, the mass flow rates, my, of each individual component (e.g., f equal to g, o or w for gas, oil or water) of the multiphase flow at the downhole pipe can be determined by the equation shown in FIG. 6. It should be noted that pressure and temperature may be measured as a single point measurement in a nearby region to the velocity and composition/hold up sensors. Nearby meaning, for example, no more than ten (downhole) pipe diameters away from those two sensors. According to an exemplary embodiment, such pressure and temperature measurements may be made on the body of the mobile vessel (200), with, for example, a pressure sensor having a small port with access to external fluid, and a thermocouple, for example, as a temperature sensor, with the active/sensing elements away from heated areas of the mobile vessel (200) and closer to an outer skin/pressure of such vessel. It should further be noted that given a known/sensed composition of the fluid mixture; a thermodynamic state (e.g., pressure and temperature) of each fluid; and (a well-known in the art) fluid-specific equation of state that describes the thermodynamics, the mass density, p_{f}, of each fluid component can be calculated.

With further reference to FIG. 6, according to a nonlimiting embodiment of the present disclosure, the processing steps (610, 615) may be performed during the first measurement phase M1 inside of the mobile vessel (e.g., 200 of FIG. 3) at the downhole of the pipe. In other words, processing hardware/firmware/software (i.e., means) for performing of such steps may be included inside of the mobile vessel. In particular, the processing hardware (e.g., processing means) may include any one or more of a microprocessor, microcontroller, field programmable gate array, memory, and/or other analog or digital circuits for performing the processing steps (610, 615). Data sensed during the processing steps (610, 615) may be stored on a memory for immediate processing by the processing steps (620, 625, 630) or for later processing by such steps. Later processing may be based on performing of the processing steps (620, 625, 630) of the second measurement phase, M2, at a location that is remote/external to the mobile vessel and/or the oil well. This may include processing at the surface of the oil well after being provided first measurement phase M1 data via, for example, immersible storage module that can be injected into the flow and float/flow with the downhole fluid to, for example, the surface of the well.

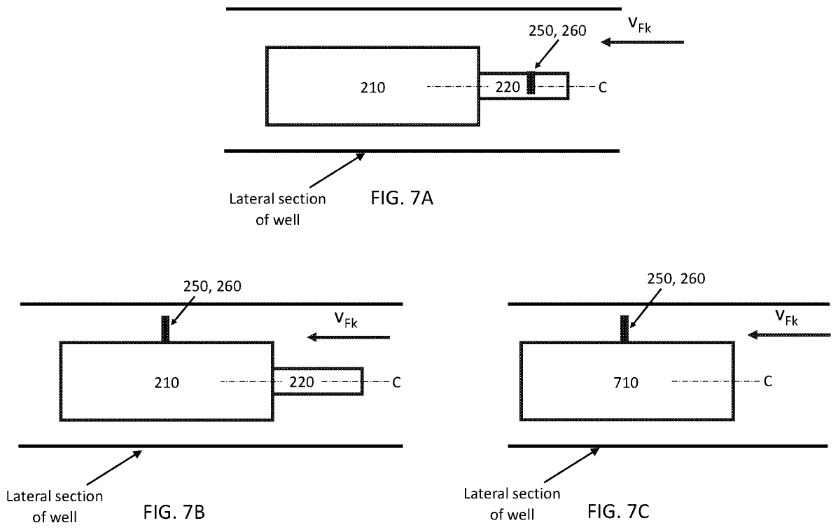

Protrusion of the flow velocity and composition sensors (e.g., 250 and 260 of FIG. 3) into the flow of the fluid mixture may cause undesired perturbations in the flow that may affect measurements/sensing performed by other sensors that may be integrated into the mobile vessel. It follows that according to an embodiment of the present disclosure one or more of the flow sensor or the composition sensor may be retractable into the mobile vessel. This is shown in FIG. 7A, wherein the flow velocity and composition sensors (250, 260) are shown retracted into a space within the nose (220) of the mobile vessel (200). In such configuration, the sensors (250, 260) may remain in the retracted position so long flow velocity and/or composition measurements are not performed. For performing of the above-described time-correlated measurements, the flow velocity and composition sensors (250, 260) may be extended outwards the nose (220) in a position as shown in FIG. 3.

It should be noted that the flow velocity and composition sensors (250, 260) may be mounted on any part of the mobile vessel (200) according to the present teachings, including the main body (210) as shown in FIG. 7B. In such configuration, a different calibration routine may be performed to derive the effective fluid velocity in view of a different flow restriction imposed in a sensing region of the sensors. Furthermore, it should be noted that the teachings according to the present disclosure may apply to any mobile vessel configured for immersion in harsh environments such as, for example, a downhole of a well, including the lateral section of the well (e.g., lateral section of well_1 shown in FIG. 1). In other words, the mobile vessel may not necessarily be a mobile robot with advanced technologies. Rather, it can be a simple submersion vessel (710) as shown in FIG. 7C fitted with the flow velocity and composition sensors as described above, the submersion vessel configured to be introduced/submersed into the fluid mixture of the downhole of a well or other.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A system for measuring mass flow rate in a downhole pipe of a lateral section of a well, the system comprising:
a mobile vessel configured for submersion into a fluid mixture of the downhole pipe;
a flow velocity sensor attached to the mobile vessel, the flow velocity sensor configured to rotate about a longitudinal center axis of the mobile vessel for placement according to a plurality of discrete angular positions of a velocity sensing region of the flow velocity sensor;
a composition sensor attached to the mobile vessel, the composition sensor configured to rotate about the longitudinal center axis of the mobile vessel for placement according to a plurality of discrete angular positions of a composition sensing region of the composition sensor; and
processing means configured to
use a plurality of time-series measurements of velocity and composition of the fluid mixture sensed at the plurality of discrete angular positions of the velocity and composition sensing regions to determine a total cross-sectional area and flow velocity of each of a plurality of fluid components of the fluid mixture.

2. The system according to claim 1, wherein:
the plurality of time-series measurements of the velocity are time-correlated with the plurality of time-series measurements of the composition.

3. The system according to claim 1, wherein:
the system further comprises a pressure sensor and a temperature sensor, and
the processing means is further configured to
use pressure and temperature measurements sensed by the pressure and temperature sensors as thermodynamic state variables to determine a mass density of each of the plurality of fluid components of the fluid mixture.

4. The system according to claim 1, wherein:
the processing means is further configured to
combine the total cross-sectional area, the flow velocity, and the mass density of each of the plurality of fluid components of the fluid mixture to determine a corresponding mass flow rate.

5. The system according to claim 1, wherein:
the processing means is further configured to use a measurement time length of each of the plurality of time-series measurements to determine the total cross-sectional area and the flow velocity of each of the plurality of fluid components of the fluid mixture.

6. The system according to claim 5, wherein:
the measurement time length is based on an observed flow velocity of the fluid mixture.

7. The system according to claim 1, wherein:
the processing means is further configured to
use geometry parameters that define portions of the composition and flow velocity sensors that interact with the fluid mixture to determine the flow velocity of each of the plurality of fluid components of the fluid mixture.

8. The system according to claim 7, wherein:
the geometry parameters include geometries of respective protrusions of the flow velocity and sensors into the flow, including height and/or diameter of the respective protrusions, and/or relative distance between the respective protrusions.

9. The system according to claim 1, wherein:
the plurality of discrete angular positions of the velocity sensing region are offset from the plurality of discrete angular positions of the composition sensing region.

10. The system according to claim 1, wherein:
the mobile vessel comprises a first element having a substantially tubular shape about the longitudinal center axis, the first element configured to rotate about the longitudinal center axis, and
each sensor of the flow velocity and composition sensors include an enclosure or a mast that protrude from the first element.

11. The system according to claim 10, wherein:
the enclosure or mast include a cylindrical shape that is radially attached to the first element.

12. The system according to claim 1, wherein:
the fluid mixture comprises gas, oil and water.

13. The system according to claim 1, wherein:
the processing means includes a first processing means internal to the mobile vessel, and a second processing means external to the mobile vessel.

14. The system according to claim 13, wherein:
the first processing means includes storage means to store data corresponding to the plurality of time-series measurements, and
the second processing means includes means to determine the total cross-sectional area and flow velocity of each of a plurality of fluid components of the fluid mixture based on the stored data.

15. A system for measuring mass flow rate of a fluid mixture, the system comprising:
a submersion vessel configured for submersion into the fluid mixture;
a flow velocity sensor attached to the submersion vessel, the flow velocity sensor configured to rotate about a longitudinal center axis of the submersion vessel according to a plurality of discrete angular positions;
a composition sensor attached to the submersion vessel, the composition sensor configured to rotate about the longitudinal center axis of the submersion vessel according to a plurality of discrete angular positions; and
processing means configured to
use a plurality of time-series measurements of velocity and composition of the fluid mixture sensed at the plurality of discrete angular positions to determine a total cross-sectional area and flow velocity of each of a plurality of fluid components of the fluid mixture.

16. The system according to claim 15, wherein:
the plurality of time-series measurements of the velocity are time-correlated with the plurality of time-series measurements of the composition.

17. The system according to claim 15, wherein:
the system further comprises a pressure sensor and a temperature sensor, and
the processing means is further configured to
use pressure and temperature measurements sensed by the pressure and temperature sensors as thermodynamic state variables to determine a mass density of each of the plurality of fluid components of the fluid mixture.

18. The system according to claim 15, wherein:
the processing means is further configured to
combine the total cross-sectional area, the flow velocity, and the mass density of each of the plurality of fluid components of the fluid mixture to determine a corresponding mass flow rate.

19. The system according to claim 15, wherein:
the processing means is further configured to
use a measurement time length of each of the plurality of time-series measurements to determine the total cross-sectional area and the flow velocity of each of the plurality of fluid components of the fluid mixture.

20. A method for measuring mass flow rate velocity of a fluid mixture, the method comprising:
performing a plurality of time-series measurements of velocity and composition of the fluid mixture at a plurality of discrete angular positions relative to a center axis;
based on the performing, obtaining time-correlated measurements of the velocity and composition at each of the discrete angular positions;
based on the obtaining, identifying a plurality of fluid components of the fluid mixture; and
based on the obtaining and the identifying, determining a total cross-sectional area and flow velocity of each of the plurality of fluid components.

21. The method according to claim 20, further comprising:
measuring a pressure sensor and a temperature of the fluid mixture;
based on the measuring, determining a mass density of each of the plurality of fluid components of the fluid mixture; and
combining the total cross-sectional area, the flow velocity, and the mass density of each of the plurality of fluid components to determine a corresponding mass flow rate.
